(19) United States
(12) Patent Application Publication
(10) Pub. No.: US 2013/0207778 A1
(43) Pub. Date: Aug. 15, 2013

(54) ACCESSORY FOR A MOBILE DEVICE

(71) Applicant: XceedID Corporation, (US)

(72) Inventors: Jeffrey Neafsey, Golden, CO (US); Kelly Bruggeman, Littleton, CO (US); Todd Eberwine, Lakewood, CO (US)

(21) Appl. No.: 13/766,594

(22) Filed: Feb. 13, 2013

Related U.S. Application Data
(60) Provisional application No. 61/598,215, filed on Feb. 13, 2012.

(51) Int. Cl. G05B 1/01

(52) U.S. Cl. CPC G05B 1/01
USPC 340/5.61

(57) ABSTRACT

A mobile device includes an accessory. The accessory may include two communication modules. The accessory is configured to receive data from the mobile device wirelessly. The accessory is configured to store the data. The accessory is configured to transmit at least a portion of the data to a reader device.

### CROSS-REFERENCE TO RELATED APPLICATIONS

The present application claims the benefit of U.S. Provisional Patent Application No. 61/598,215, filed on Feb. 13, 2012, which is hereby incorporated by reference in its entirety.

### BACKGROUND

The present application generally relates to mobile devices, and more particularly, but not exclusively, relates to an accessory for a mobile device. Accessories for mobile devices may provide one or more functions. Some existing systems have various shortcomings relative to certain applications. Accordingly, there remains a need for further contributions in this area of technology.

### SUMMARY

One embodiment of the present application is a unique mobile device accessory. Other embodiments include apparatuses, systems, devices, hardware, methods, and combinations for mobile device accessories. Further embodiments, faults, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic diagram of an exemplary system.

FIG. 2 is a schematic diagram of a computing device.

FIG. 3 is a schematic flow diagram of an exemplary process for utilizing a mobile device accessory for receiving and transmitting data.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one ordinarily skilled in the art to which the invention relates.

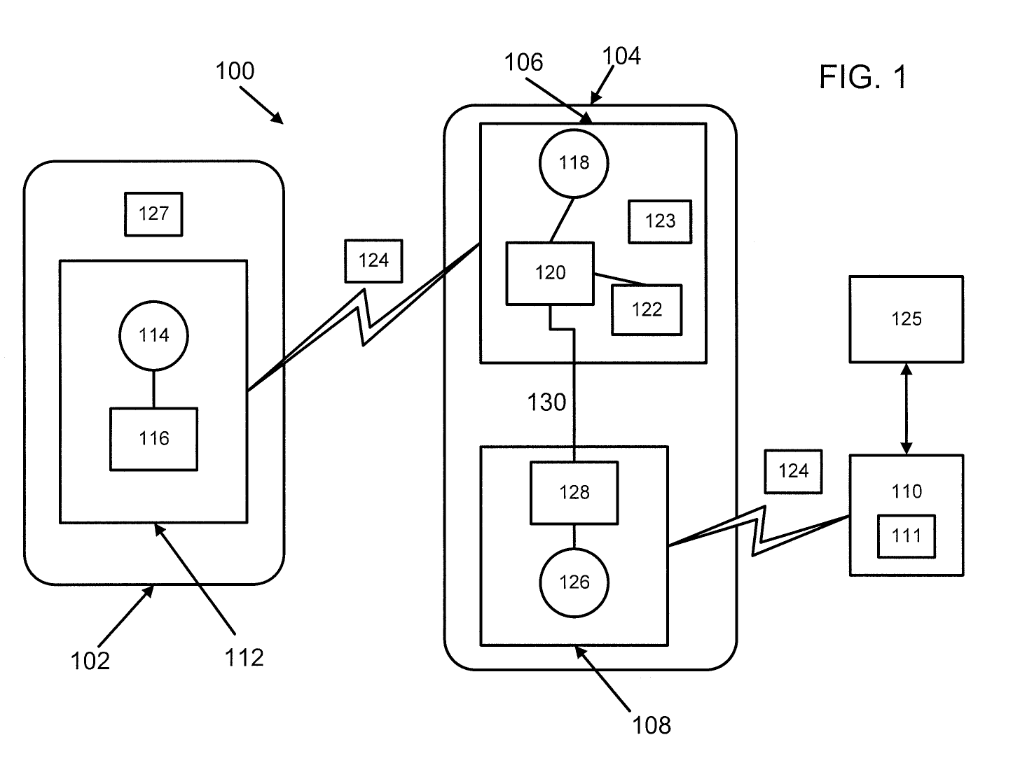

FIG. 1 illustrates a schematic block diagram of an exemplary system 100. In the embodiment shown in FIG. 1, the system 100 is an access control system. However, the system 100 may also be a payment system, a transit system, a vending system, or the like. The system 100 includes a mobile device 102 that may be coupled to an accessory 104, which in the embodiment of FIG. 1 is a case. Other types of accessories 104 are contemplated such as a key fob, a card-type accessory, and the like. The mobile device 102 may be a mobile phone, such as a cell phone or smartphone, a tablet computer, such as an iPad, or any other type of mobile computing device. In the embodiment shown in FIG. 1, the mobile device 102 is a mobile phone.

The accessory 104 includes at least two communication modules. One communication module operates over one carrier frequency or network band. Another communication module operates over another carrier frequency or network band that is different than the first carrier frequency. In the embodiment shown in FIG. 1, one communication module is a Bluetooth system 106 and the other communication module is a Near Field Communication (NFC) system 108. In the embodiment shown in FIG. 1, the Bluetooth system 106 is a Bluetooth low energy (BLE) system. It is contemplated that other wireless communication technologies may be used in place of the Bluetooth system 106 and/or NFC system 108.

The system 100 further includes a reader device 110. The reader device 110 may be part of system for access control, payment, transit, or any other application. Moreover, the reader 110 includes an NFC system 111 to communicate with and receive data from the NFC system 108 of the mobile device 102. In the embodiment shown in FIG. 1, the reader device 110 is an NFC reader for an electronic lock.

The mobile device 102 includes one or more communication modules including a Bluetooth system 112 to communicate with the Bluetooth system 106 of the accessory 104. The Bluetooth system 112 includes a Bluetooth antenna 114 and chip 116. The Bluetooth system 112 of the mobile device 102 is powered from the battery (not shown) of the mobile device 102. Other types of communication modules and protocols are contemplated and may be used to communicate with the accessory.

The Bluetooth system 106 of the accessory 104 includes a Bluetooth antenna 118, a Bluetooth chip 120, and a battery 122. The Bluetooth system 106 receives data 124, such as a credential, from the Bluetooth system 112 of the mobile device 102. The mobile device 102 includes an application 127 that is configured to call a Bluetooth application programming interface (API) so that the mobile device 102 may transmit the data 124 to the Bluetooth system 106. The Bluetooth system 106 may store the data 124 in the chip 120. The data 124 may be a credential, a facility code, a badge identifier, cryptographic keys, payment information, and/or any other secret, secure, or confidential information that may be used to process a transaction. The Bluetooth chip 120 includes a processing device with operating logic to control operation of the Bluetooth system 106.

The Bluetooth system 106 further includes a switching device 123 to power on the Bluetooth chip 120 of the Bluetooth system 106. The switching device 123 includes a button that when pressed, powers on the Bluetooth chip 120. When the Bluetooth system 106 powers on, the Bluetooth system 106 proceeds into a pairing mode in which the Bluetooth system 106 pairs with the Bluetooth system 112. It is contemplated that the Bluetooth system 106 may also be energized or awakened from a sleep or low-power state by receiving a signal from the Bluetooth system 112 of the mobile device 102. The application 127 may be used to initiate transmission of the signal from the Bluetooth system 112 to awaken the Bluetooth system 106. It is contemplated that the awaken signal from the Bluetooth system 112 may initiate the pairing process between the mobile device 102 and the accessory 104.

The NFC system 108 includes an NFC antenna 126 and an NFC chip 128. The NFC chip 128 receives the data 124 from the Bluetooth chip 120 via a wired connection 130. In one embodiment, the Bluetooth system 106 communicates with the NFC system 108 via the wired connection 130. It is contemplated, however, that the Bluetooth system 106 communicates with the NFC system 108 via a wireless connection (not shown) in other embodiments. The NFC chip 128 includes a processing device and operating logic to control operation of the NFC system 108.

The NFC system 108 transmits the data 124 to the reader device 110. In one embodiment, the NFC system 108 is a passive system in which electromagnetic radiation from the NFC system 111 is received by the NFC antenna 126 powers the NFC chip 128 and NFC antenna 126 such that the NFC system 108 transmits some or all of the data 124 to the reader 110. In this configuration, the NFC chip 128 is powered by the reader field of the reader device 110. It is contemplated that in some embodiments the NFC system 108 is an active system that includes its own battery (not shown) or shares the battery 122 that is part of the Bluetooth system 106. If the NFC system 108 is an active system, the application 127 of the mobile device 102 may send a command via Bluetooth system 112 to the Bluetooth system 106 which in turn sends a power on command to the NFC system 108 for transmission of the data 124 to the reader device 110.

The reader device 110 is configured to receive at least a portion of the data 124 from the NFC system 108 of the accessory 104 of the mobile device 102. The system 100 includes a processing system 125, which receives the data 124 from the reader device 110. The processing system 125 utilizes the data 124 to process a transaction such as making an access control decision or determining whether a payment request should be granted or denied. In the embodiment shown in FIG. 1, the processing system 125 is an access control system including an access control panel and/or controller. It is contemplated that in some embodiments the reader device 110 may perform processing steps of the processing system 125. It is also contemplated that the processing system 125 may be a remote server (e.g., a cloud service) that communicates directly to the reader device 110.

The Bluetooth chip 116, the Bluetooth chip 120, and the NFC chip 128 each include components, programming, and circuitry suitable to its particular application, and also include communication circuitry operatively coupled their respective antennas. The chips 116, 120, and 128 are arranged to perform bidirectional or unidirectional communications with antennas 114, 118, and 126. The circuitry in chips 116, 120, and 128 may be configured to provide appropriate signal conditioning to transmit and receive desired information (data), and correspondingly may include filters, amplifiers, limiters, modulators, demodulators, CODECs, digital signal processing, and/or different circuitry or functional components as would occur to those skilled in the art to perform the desired communications. In addition, the chips 116, 120, and 128 may be adapted to control various configurations that can be provided with their respective antennas.

In one nonlimiting form, the chips 116, 120, and 128 include circuitry to store or process information, modulate or demodulate a radio-frequency (RF) signal, or the like, or a combination thereof. The information may include data 124, a credential, identification information, status information, or any other type of information that would occur to those ordinarily skilled in the art. It should be appreciated that while only one antenna is depicted for each of the chips 116, 120, and 128, multiple antennas may be utilized. In addition, the communication modules described in the present application generally comprise transceivers, among other things, to communicate data.

In one embodiment, the reader device 110 is part of a door locking mechanism, such as electronic lock, in which the data 124 is a credential. However, it is contemplated that in other embodiments the reader 110 may be part of any type of system such as access control, payment, transit, or any other application. Generally, the credential is a string of bits of variable length. The length of the credential depends on the type or format of the credential. Moreover, the present application allows mobile devices 102 to be utilized similar to a traditional plastic card credential for access control, payment, transit, or any other application.

The present application generally allows an accessory 104 for a mobile device 102 to be manufactured that does not physically connect to a port on the mobile device 102 while still allowing the NFC credential 124 to be programmed over-the-air. Generally, no physical connectivity to the mobile device 124 is required, thus allowing the accessory 104 to expose the existing phone connector for docking purposes because a Bluetooth connection is utilized. It is contemplated that in some embodiments the electromagnetic radiation from the reader device 110 may power the Bluetooth system 106.

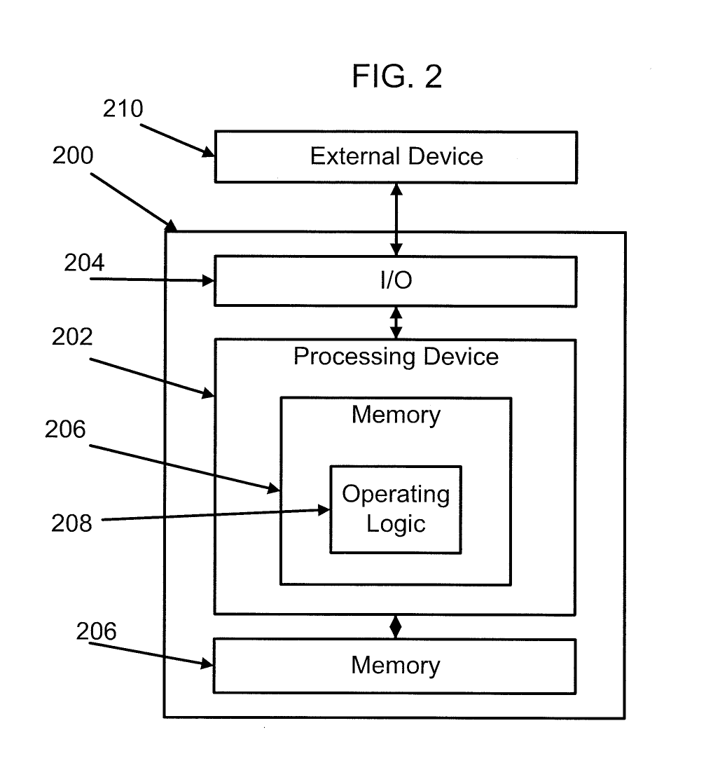

FIG. 2 is a schematic block diagram of a computing device 200. The computing device 200 is one example of a mobile device, accessory, reader device, and/or processing system configuration that may be utilized in connection with the mobile device 102, accessory 104, reader device 110, and/or processing system 125 shown in FIG. 1. Computing device 200 includes a processing device 202, an input/output device 204, memory 206, and operating logic 208. Furthermore, computing device 200 communicates with one or more external devices 210.

The input/output device 204 may be any type of device that allows the computing device 200 to communicate with the external device 210. For example, the input/output device 204 may be a transceiver, network adapter, network card, interface, or a port (e.g., a USB port, serial port, parallel port, an analog port, a digital port, VGA, DVI, HDMI, FireWire, CAT 5, or any other type of port or interface). The input/output device 204 may be comprised of hardware, software, firmware, and/or state machines. It is contemplated that the input/output device 204 may include more than one transceiver, network adapter, network card, or port.

The external device 210 may be any type of device that allows data to be inputted to or outputted from the computing device 200. For example, the external device 210 may be a Bluetooth system including a Bluetooth antenna and Bluetooth chip, a mobile device, an accessory, a reader device, equipment, a handheld computer, a diagnostic tool, a controller, a computer, a server, a processing system, a sensor, a printer, a display, an alarm, an illuminated indicator such as a status indicator, a keyboard, a mouse, or a touch screen display. Furthermore, it is contemplated that the external device 210 may be integrated into the computing device 200. For example, the computing device 200 may be a mobile phone, a handheld diagnostic tool, a smartphone, a laptop computer, or a tablet computer in which case the display would be an external device 210, but the display is integrated with the computing device 200 as one unit, which is consistent with the general design of mobile phones, handheld diagnostic tools, smartphones, laptop computers, tablet computers, and the like. It is further contemplated that there may be more than one external device in communication with the computing device 200. The accessory 104 is one example of an external device 210.

Processing device 202 can be a programmable type, a dedicated, hardwired state machine; or a combination of these; and it can further include multiple processors, Arithmetic-Logic Units (ALUs), Central Processing Units (CPUs), Digital Signal Processors (DSPs), or the like. Processing devices 202 with multiple processing units may utilize distributed, pipelined, and/or parallel processing. Processing device 202 may be dedicated to performance of just the operations described herein or may be utilized in one or more additional applications. In the depicted faun, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

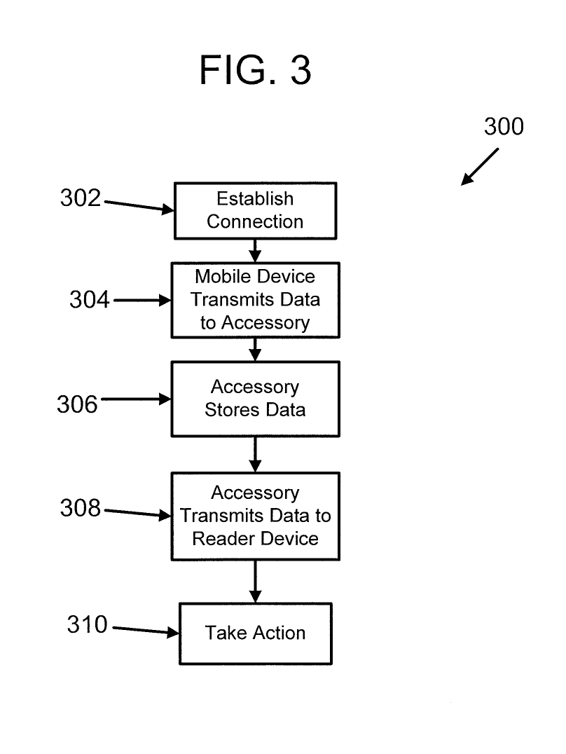

FIG. 3 illustrates a schematic flow diagram of an exemplary process 300 for storing data in a mobile device accessory and transmitting at least a portion of the data from the accessory to a reader device. Operations illustrated for all of the processes in the present application are understood to be examples only, and operations may be combined or divided, and added or removed, as well as re-ordered in whole or in part, unless explicitly stated to the contrary.

Process 300 begins at operation 302 in which a connection between the Bluetooth system 112 of the mobile device 102 and the Bluetooth system 106 of the accessory 104 is established. Establishing a connection may include powering on the mobile device 102, the accessory 104, or powering on both. If the mobile device 102 and the accessory 104 have not previously established a connection, the mobile device 102 and the accessory 104 may be paired by pressing the switching device 123. After the mobile device 102 and the accessory 104 have established a connection once, the mobile device 102 and the accessory should automatically establish connection whenever both Bluetooth systems 112 and 106 are powered on. In addition, after the mobile device 102 and the accessory 104 have paired, the Bluetooth system 106 may remain powered on for an indefinite amount of time or until the battery 122 is depleted because of the low power consumption of Bluetooth low energy. As discussed above, it is contemplated that the Bluetooth system 112 may send an awaken signal to the Bluetooth system 106 to awaken from a sleep or low-power state. The awaken signal may also place the Bluetooth system 106 into a pairing mode.

Process 300 then proceeds from operation 302 to operation 304. At operation 304, the mobile device 102 transmits data 124 to the accessory 104 utilizing the established Bluetooth connection. The Bluetooth system 106 of the accessory 104 receives the data 124 from the Bluetooth system 112.

Process 300 then proceeds from operation 304 to operation 306. At operation 306, the Bluetooth system 106 sends at least a portion of the data 124 to the NFC system 108. The NFC system 108 stores the data 124 that it received in the NFC chip 128. It is contemplated that the Bluetooth system 106 may store the data 124 in the Bluetooth chip 120.

Process 300 then proceeds from operation 306 to operation 308. At operation 308, the NFC system 108 of the accessory 104 transmits at least a portion of the data 124 to the reader device 110. An implicit or an express action request is included with the transmission of the data 124 to the reader device 110. The action request is a request for a determination to be made regarding access, payment, transit, vending, or the like based on the data 124.

The NFC system 108 may be a passive system in which the data 124 is transmitted automatically when the NFC system 108 is placed within a certain range of the reader device 110. Or, the NFC system 108 may be an active system that is powered on in response to a command from the mobile device 102 and/or the Bluetooth system 106.

Process 300 then proceeds from operation 308 to operation 310. At operation 310, the reader device 110 may process the data 124 and/or transmit the data to the processing system 125 for processing. The reader 110 and/or the processing system 125 may make an access control decision, a payment decision, or the like depending on the type of system. Once the decision has been made an action is carried out such as unlocking a lock or granting or denying a payment.

The various aspects of the process 300 in the present application may be implemented in operating logic 208 as operations by software, hardware, artificial intelligence, fuzzy logic, or any combination thereof, or at least partially performed by a user or operator. In certain embodiments, operations represent software elements as a computer program encoded on a computer readable medium, wherein the mobile device 102, accessory 104, reader device 110, and/or processing system 125 performs the described operations when executing the computer program.

In one nonlimiting example, an APPLE IPHONE is the mobile device 102. The accessory 104 is a case for the IPHONE. The case includes a Bluetooth system and a NFC system. The reader device 104 is an NFC reader. The Bluetooth system of the case communicates with the Bluetooth system of the IPHONE to receive a credential from the IPHONE. The Bluetooth system of the case transmits the credential to the NFC system of the case where the credential is stored. The NFC system transmits at least a portion of the credential to the NFC reader.

One embodiment of the present application includes an apparatus, comprising: a Bluetooth antenna coupled to a Bluetooth chip and a battery coupled to the Bluetooth chip; a NFC antenna coupled to a NFC chip; and a case including the Bluetooth antenna, the Bluetooth chip, the battery, the NFC antenna, and the NFC chip, wherein the NFC chip is coupled to the Bluetooth chip.

Additional features of the embodiment of the present application may include one or more of the following: wherein the NFC chip includes memory operable to store a credential; wherein the Bluetooth chip is structured to transmit a credential to the NFC chip; a mobile device located inside the case, wherein the mobile device is structured to transmit a credential to the Bluetooth antenna and Bluetooth chip; and/or wherein the mobile device is a mobile phone.

Another embodiment of the present application includes a method, comprising: storing a Bluetooth system and a NFC system in a case; receiving data with the Bluetooth system from a mobile device; and transferring the data from the Bluetooth system to the NFC system.

Additional features of the embodiments of the present application may include one or more of the following: wherein the Bluetooth system includes an antenna, a battery, and a chip; wherein the NFC system includes an antenna and a chip; retaining the mobile device with the case; storing the data in memory in the NFC system; transmitting the data from the NFC system to a reader; wherein the reader is a door lock; wherein the NFC system is passive; and/or wherein the data is a credential.

Yet another embodiment of the present application includes an apparatus, comprising: a mobile phone in a case, wherein the case includes a Bluetooth system and a NFC system, the mobile phone including means to transmit a data to the Bluetooth system, wherein the Bluetooth system is operable to transmit the data to the NFC system, wherein the NFC system includes memory to store the data.

Additional features of the embodiments of the present application may include the following: wherein the data is a credential.

Another embodiment of the present application includes an apparatus, comprising: a case including means for receiving data from a mobile device, the case further including means for storing the data, and the case further including means for transmitting the data to a reader.

Additional features of the embodiment of the present application may include one or more of the following: wherein the receiving means includes a Bluetooth system; wherein the storing means and transmitting means includes a NFC system; and/or wherein the data is a credential.

Yet another embodiment of the present application includes an apparatus, comprising: a mobile device including a wireless transceiver configured to communicate secret data over a first carrier frequency; and an accessory coupled to the mobile device, the accessory including a first communication module and a second communication module, wherein the first communication module is configured to communicate over the first carrier frequency and the second communication module is configured to communicate over a second carrier frequency that is different than the first carrier frequency, wherein the first communication module is configured to wirelessly receive the secret data from the mobile device over the first carrier frequency, wherein the second communication module is configured to receive the secret data from the first communication module and store the secret data, wherein the second communication module is further configured to wirelessly transmit at least a portion of the secret data to a reader device over the second carrier frequency.

Additional features of the embodiment may include: wherein the first communication module is a Bluetooth system and the second communication module is an NFC system; wherein the mobile device is a mobile phone; wherein the reader device is part of an access control system; wherein the accessory is one of a case, a key fob, and a card-type accessory; and/or wherein the first communication module and the second communication module communicate via a wired connection.

Another embodiment of the present application may includes a method, comprising: establishing a first wireless connection between a mobile device and an accessory; transmitting secret data from the mobile device to the accessory over the first wireless connection; receiving and storing the secret data in the accessory; establishing a second wireless connection between the accessory and a reader device; and transmitting at least a portion of the secret data from the accessory to the reader device over the second wireless connection.

Additional features of the embodiment may include: receiving the secret data from the mobile device with a first communication system of the accessory; and transmitting the at least a portion of the secret data to the reader device with a second communication system of the accessory; wherein the first communication system is a Bluetooth system and the second communication system is an NFC system; activating the second communication system with the mobile device; determining whether to grant an action request based on an analysis of the at least a portion of the secret data; and/or wherein the action request is one of an access request, and a payment request, a transit request, and a vending request.

Yet another embodiment of the present application includes an apparatus, comprising: a mobile device coupled to an accessory, wherein the mobile device includes means for transmitting secure data to the accessory, wherein the accessory includes means for receiving the secure data from the mobile device and means for transmitting at least a portion of the secure data to another device.

Additional features of the embodiment may include: wherein the accessory is a mobile device case; wherein the another device is an electronic lock that is part of an access control system; and/or wherein the means for receiving the secure data from the mobile device includes a Bluetooth communication module and the means for transmitting at least a portion of the secure data to another device includes an NFC communication module.

Another embodiment of the present application includes a system, comprising: a mobile device including a wireless transceiver configured to communicate secure data; an accessory including a first communication module and a second communication module, wherein the first communication module is configured to wirelessly receive the secure data from the mobile device; and a reader device configured to receive the secure data from the second communication module of the accessory.

Additional features of the embodiment may include: a processing system configured to receive the secure data from the reader device and to process the secure data to determine whether to grant an action request; wherein the system is an access control system; and/or wherein the first communication module comprises a Bluetooth system and the second communication module comprises an NFC system.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus, comprising:
a mobile device including a wireless transceiver configured to communicate secret data over a first carrier frequency; and
an accessory coupled to the mobile device, the accessory including a first communication module and a second communication module, wherein the first communication module is configured to communicate over the first carrier frequency and the second communication module is configured to communicate over a second carrier frequency that is different than the first carrier frequency, wherein the first communication module is configured to wirelessly receive the secret data from the mobile device over the first carrier frequency, wherein the second communication module is configured to receive the secret data from the first communication module and store the secret data, wherein the second communication module is further configured to wirelessly transmit at least a portion of the secret data to a reader device over the second carrier frequency.

2. The apparatus of claim 1, wherein the first communication module is a Bluetooth system and the second communication module is an NFC system.

3. The apparatus of claim 1, wherein the mobile device is a mobile phone.

4. The apparatus of claim 1, wherein the reader device is part of an access control system.

5. The apparatus of claim 1, wherein the accessory is one of a case, a key fob, and a card-type accessory.

6. The apparatus of claim 1, wherein the first communication module and the second communication module communicate via a wired connection.

7. A method, comprising:
establishing a first wireless connection between a mobile device and an accessory;
transmitting secret data from the mobile device to the accessory over the first wireless connection;
receiving and storing the secret data in the accessory;
establishing a second wireless connection between the accessory and a reader device; and
transmitting at least a portion of the secret data from the accessory to the reader device over the second wireless connection.

8. The method of claim 7, further comprising:
receiving the secret data from the mobile device with a first communication system of the accessory; and
transmitting the at least a portion of the secret data to the reader device with a second communication system of the accessory.

9. The method of claim 8, wherein the first communication system is a Bluetooth system and the second communication system is an NFC system.

10. The method of claim 9, further comprising:
activating the second communication system with the mobile device.

11. The method of claim 7, further comprising:
determining whether to grant an action request based on an analysis of the at least a portion of the secret data.

12. The method of claim 11, wherein the action request is one of an access request, a payment request, a transit request, and a vending request.

13. An apparatus, comprising: a mobile device coupled to an accessory, wherein the mobile device includes means for transmitting secure data to the accessory, wherein the accessory includes means for receiving the secure data from the mobile device and means for transmitting at least a portion of the secure data to another device.

14. The apparatus of claim 13, wherein the accessory is a mobile device case.

15. The apparatus of claim 13, wherein the another device is an electronic lock that is part of an access control system.

16. The apparatus of claim 13, wherein the means for receiving the secure data from the mobile device includes a Bluetooth communication module and the means for transmitting at least a portion of the secure data to another device includes an NFC communication module.

17. A system, comprising:
a mobile device including a wireless transceiver configured to communicate secure data;
an accessory including a first communication module and a second communication module, wherein the first communication module is configured to wirelessly receive the secure data from the mobile device; and
a reader device configured to receive the secure data from the second communication module of the accessory.

18. The system of claim 17, further comprising:
a processing system configured to receive the secure data from the reader device and to process the secure data to determine whether to grant an action request.

19. The system of claim 17, wherein the system is an access control system.

20. The system of claim 17, wherein the first communication module comprises a Bluetooth system and the second communication module comprises an NFC system.
